(19) United States
(12) Patent Application Publication
(10) Pub. No.: US 2009/0061842 A1
(43) Pub. Date: Mar. 5, 2009

(54) Apparatus and method for interference cancellation in wireless communication system

(75) Inventors: Sung-Woo Park, Suwon-si (KR); Keun-Chul Hwang, Seongnam-si (KR); Soon-Young Yoon, Seoul (KR); Heon-Ki Chae, Seongnam-si (KR)

Correspondence Address: DOCKET CLERK, P.O. DRAWER 800889, DALLAS, TX, 75380, US

(73) Assignee: Samsung Electronics Co., Ltd., Suwon-si (KR)

(21) Appl. No.: 12/229,925

(22) Filed: Aug. 28, 2008

(30) Foreign Application Priority Data
Aug. 31, 2007 (KR) 2007-0088018

(51) Int. Cl. H04W 40/16

(52) U.S. Cl. 455/422.1

(57) ABSTRACT

An apparatus and a method for interference cancellation in a wireless communication system are provided. The method includes receiving channel information from one or more terminals; classifying the terminals into terminals interfered by a neighbor cell and terminals not interfered by the neighbor cell based on the channel information of the terminals; and allocating the terminals interfered by the neighbor cell and the terminals not interfered by the neighbor cell into different resource regions. The transmitter forms the beam taking into consideration the neighbor-cell interference by acquiring the channel information of the neighbor-cell terminals interfered by the transmitter and the scheduled terminal information during beamforming.

### CROSS-REFERENCE TO RELATED APPLICATION(S) AND CLAIM OF PRIORITY

This application claims priority under 35 U.S.C. § 119 (a) to a Korean patent application filed in the Korean Intellectual Property Office on Aug. 31, 2007 and assigned Serial No. 2007-88018, the entire disclosure of which is hereby incorporated by reference.

### TECHNICAL FIELD OF THE INVENTION

The present invention relates to an apparatus and a method for canceling interference of a neighbor cell in a wireless communication system. More particularly, the present invention relates to an apparatus and a method for mitigating interference affected to a neighbor cell using a transmit beamforming in a base station of a wireless communication system.

### BACKGROUND OF THE INVENTION

A multi-cell wireless communication system having a frequency reuse factor ‘1’ suffers interference of a neighbor cell in a cell overlapping area. In this situation, a demodulation performance of receivers is degraded because of an interference signal.

In this respect, the wireless communication system cancels the neighbor-cell interference at the transmitter and the receiver. For example, the receiver rejects the interference signal from the receive signal using an interference cancellation scheme. The transmitter can mitigate the interference to the neighbor cell by removing a beam pattern which acts as the interference on the neighbor cell, using the transmit beamforming scheme.

For beamforming to the receiver to provide a service, the transmitter uses channel information of the receiver. For example, in a time division duplex (TDD) wireless communication system, a downlink channel and an uplink channel have the same channel reciprocity. Accordingly, the transmitter forms the beam for the downlink using the channel information estimated from sounding signals received from the receivers.

The transmitter forms the optimum beam using a beamforming weight generated using a maximum ratio combining scheme. Without considering the neighbor-cell interference, the transmitter interferes with the receiver of other cell as shown in FIG. 1.

FIG. 1 depicts beamforming without considering the interference in a conventional wireless communication system.

A first mobile station (MS) 101 is serviced by a first base station (BS) 100 and a second MS 111 is serviced by a second BS 110.

When the first BS 100 forms the beam to the first MS 101 without taking into account interference to the neighbor cell, a signal 120 transmitted from the first BS 100 acts as considerable interference 130 to the second MS 111.

When knowing channel information of a receiver of the neighbor cell, the first BS 100 can form the beam by considering the interference in the neighbor cell. For example, by taking into account the interference in the neighbor cell, the first BS 100 can form the beam so as to mitigate the interference in the neighbor cell as shown in FIGS. 2A and 2B.

FIGS. 2A and 2B depict beam patterns of the conventional beamforming scheme in a wireless communication system.

FIG. 2A shows a beam pattern in beamforming that does not take interference into consideration, and FIG. 2B shows a beam pattern in beamforming that takes interference into consideration.

When the first BS 100 forms the beam without considering the interference, the beam pattern 200 acts as considerable interference to the second MS 111 of the neighbor cell as shown in FIG. 2A.

When the first BS 100 forms the beam by considering the interference, the beam pattern 210 is generated not to interfere with the second MS 111 of the neighbor cell as shown in FIG. 2B.

As discussed above, the transmitter forms the beam based on the neighbor-cell interference to mitigate the interference in the neighbor cell. For beamforming that takes into consideration the neighbor-cell interference, the transmitter should know the channel information of not only the serviced receiver but also the receivers of the neighbor cell. However, cells in the TDD wireless communication system differently define the transmission point of the sounding signal and the allocated resource of the sounding signal per receiver. Unfortunately, the transmitter cannot acquire the channel information of the receiver of the neighbor cell.

In addition, since the cells of the wireless communication system independently perform the scheduling, the transmitter does not know the scheduling information of the neighbor cell. As a result, in beamforming by unnecessarily considering the interference in the neighbor cell, the transmitter is subject to decrease of gain in beamforming. For instance, when the first BS 100 forms the beam by taking into account the interference of the second MS 111 but the second BS 110 does not allocate resources to the second MS 111 in FIG. 1, the first BS 100 cannot acquire gain in beamforming because it forms the beam based on the unnecessary consideration of the interference of the second MS 111.

### SUMMARY OF THE INVENTION

To address the above-discussed deficiencies of the prior art, it is a primary object of the present invention to address at least the above mentioned problems and/or disadvantages and to provide at least the advantages described below. Accordingly, an aspect of the present invention is to provide an apparatus and a method for beamforming by taking into account neighbor-cell interference in a transmitter of a wireless communication system.

Another aspect of the present invention is to provide an apparatus and a method for beamforming based on neighbor-cell interference by acquiring channel information of neighbor-cell terminals in a transmitter of a wireless communication system.

Yet another aspect of the present invention is to provide an apparatus and a method for acquiring channel information of neighbor-cell terminals by allocating a fixed sounding channel of the interfered terminals in a transmitter of a wireless communication system.

Still another aspect of the present invention is to provide an apparatus and a method for beamforming taking into consideration neighbor-cell interference based on scheduling information of an interfered terminal in a neighbor cell by round-robin scheduling the interfered terminals at a transmitter of a wireless communication.

The above aspects are achieved by providing a method for canceling interference at a transmitter in a wireless communication system. The method includes confirming channel information of one or more terminals; classifying the terminals into terminals interfered by a neighbor cell and terminals not interfered by the neighbor cell based on the channel information of the terminals; and allocating the terminals interfered by the neighbor cell and the terminals not interfered by the neighbor cell into different resource regions.

According to one aspect of the present invention, an apparatus for a transmitter in a wireless communication terminal includes a channel estimator for estimating channel information of one or more terminals; a resource determiner for classifying the terminals into terminals interfered by a neighbor cell and terminals not interfered by the neighbor cell based on the channel information of the terminals, and allocating the classified terminals into different resource regions; and a scheduler for selecting one or more terminals to be serviced by scheduling on the resource region basis.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates beamforming without considering interference in a conventional wireless communication system;

FIGS. 2A and 2B illustrate beam patterns of the conventional beamforming schemes in a wireless communication system;

FIG. 3 illustrates a frame structure for allocating a sounding channel for beamforming taking into consideration interference at a transmitter of a wireless communication system according to an exemplary embodiment of the present invention;

FIG. 4 illustrates a method for allocating the sounding channel at the transmitter of the wireless communication system according to an exemplary embodiment of the present invention;

FIG. 5 illustrates a method for recovering data at a receiver of the wireless communication system according to an exemplary embodiment of the present invention; and

FIG. 6 illustrates a transmitter for canceling neighbor-cell interference in the wireless communication system according to an exemplary embodiment of the present invention.

### DETAILED DESCRIPTION OF THE INVENTION

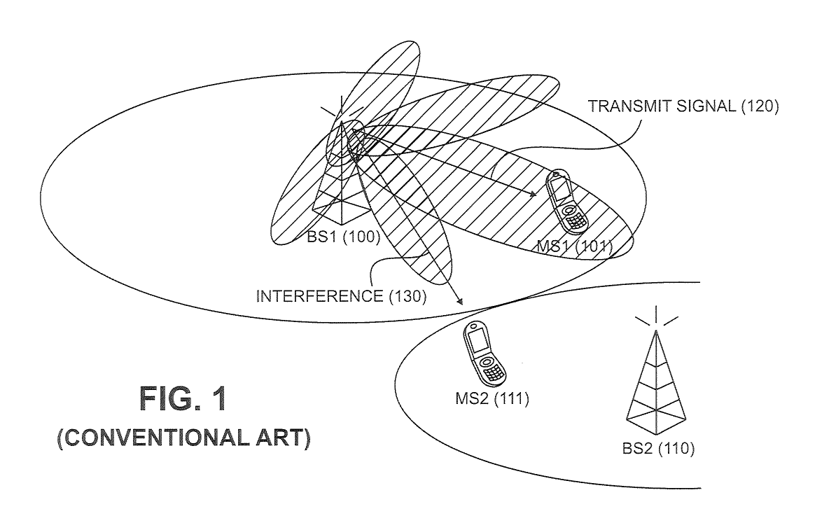

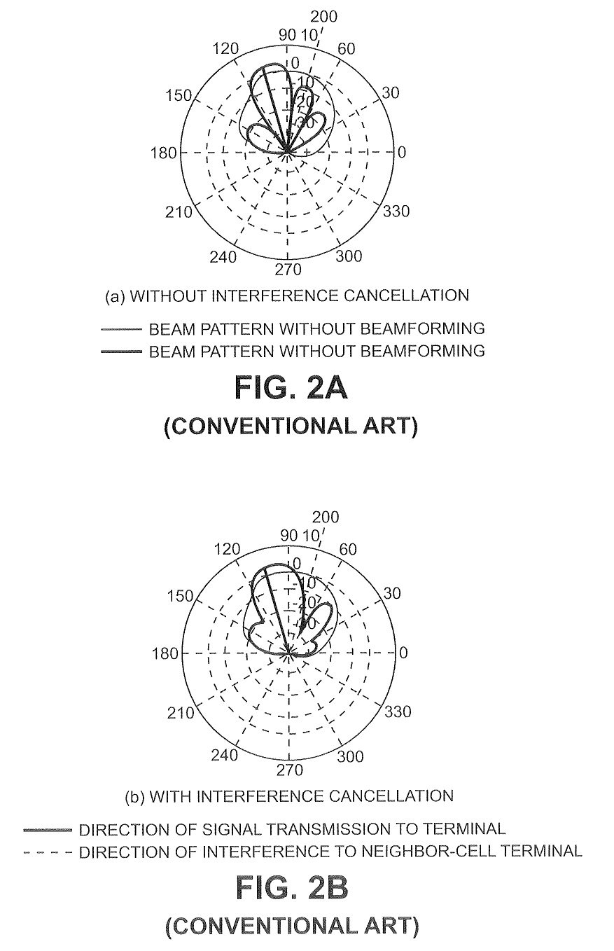

FIGS. 1 through 6, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless communication system.

Exemplary embodiments of the present invention provide a technique for beamforming by taking into account neighbor-cell interference in a wireless communication system. Particularly, the present invention provides a technique for acquiring channel information and scheduling information of terminals in a neighbor cell to form a beam taking into consideration neighbor-cell interference at a transmitter of the wireless communication system.

While a wireless communication system adopts time division duplex (TDD) and orthogonal frequency division multiple access (OFDMA) by way of example, the present invention is applicable to any other wireless communication systems.

Hereinafter, it is assumed that a base station (BS) of the wireless communication system forms a beam by taking into account interference to a neighbor cell. Note that the BS can form the beam by taking into account interference to a neighbor sector as well.

When the BS knows channel information of terminals in every beamforming, the BS generates a beamforming weight for a short term using a channel coefficient. When not knowing channels of the terminals in beamforming, the BS generates a beamforming weight for a long term using a channel correlation coefficient.

While the BS is assumed to generate the beamforming weight for a short term, the present invention also is applicable to long-term generation of the beamforming weight.

In the TDD wireless communication system, a downlink channel and an uplink channel have the same channel reciprocity. Hence, the BS forms the downlink beam using channel information estimated from sounding signals received from the terminals.

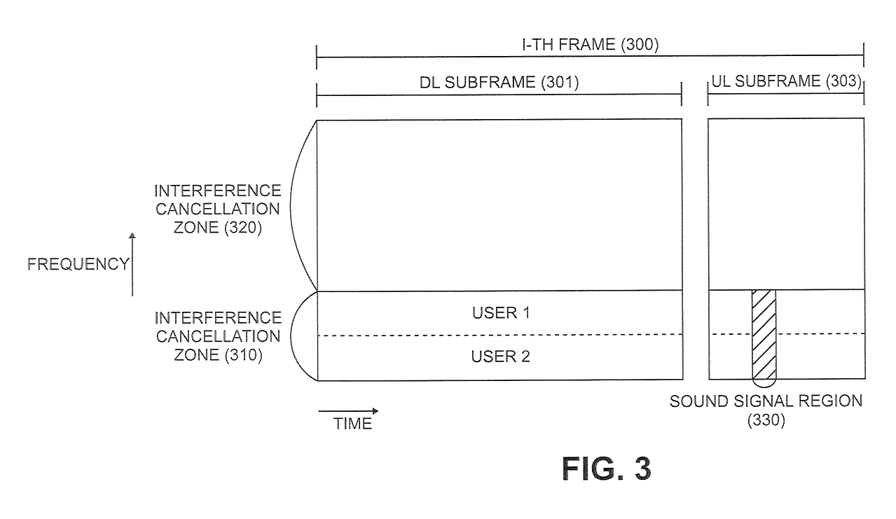

To form the beam in consideration of the interference to the neighbor cell, the BS needs to receive the sounding signals from not only terminals serviced by the BS but also a terminal in the interfered neighbor cell. The wireless communication system allocates a fixed sounding channel of the terminals so that BSs can receive the sounding signal from the terminals of the neighbor cell. For example, the wireless communication system allocates a fixed sounding channel of terminals interfered by the neighbor cell as shown in FIG. 3. Herein, the sounding channel indicates radio resources for carrying the sounding signal of the terminal.

FIG. 3 illustrates a frame structure for a transmitter to allocate a sounding channel for beamforming taking into consideration interference in a wireless communication system according to an exemplary embodiment of the present invention.

A frame 300 of FIG. 3 includes a downlink (DL) subframe 301 and an uplink (UL) subframe 303 based on time resources.

The frame 300 is divided into an interference cancellation zone 310 and a non interference cancellation zone 320 based on frequency resources. The BS determines resource regions to be allocated to terminals by taking into account channel state information (e.g., signal to interference and noise ratio (SINR)) of the terminals.

Sizes of the interference cancellation zone 310 and the non interference cancellation zone 320 can be fixed or adjusted. The interference cancellation zone 310 is the same size in every cell.

The interference cancellation zone 310 indicates a resource region for allocating terminals in a cell boundary interfered from a neighbor cell. The interference cancellation zone 310 includes a sounding channel 330 fixedly allocated so that the terminals interfered from the neighbor cell can send the sounding signal. The sounding channel 330 is fixed and allocated at the same position in the interference cancellation zone 310 in every cell. To mitigate the interference in the neighbor cell, the BS forms the beam by taking into account the neighbor-cell interference exerted on the terminals allocated to the interference cancellation zone 310 of the neighbor cells. To form the beam by taking into consideration the neighbor-cell interference, the BS needs to know channel information of the terminals assigned to the interference cancellation zone 310 of the neighbor cell. To do so, the interference cancellation zone 310 includes the fixed sounding channel 330 so that the BSs can receive the sounding signals of the terminals assigned to the interference cancellation zone 310 of the neighbor cells.

The non interference cancellation zone 320 indicates a resource region for allocating terminals in the center of the cell under no influence of the neighbor-cell interference. With respect to the terminals allocated in the non interference cancellation zone 320, the BS forms the beam without considering the interference of the neighbor cell. In doing so, the BS adaptively schedules and allocates the sounding channel based on channel state information of the terminals assigned to the non interference cancellation zone 320.

Now, descriptions explain operations of the BS for beamforming that takes into account the neighbor-cell interference based on the channel information of neighbor-cell terminals acquired through the sounding channel 330 fixedly allocated in the interference cancellation zone 310 of FIG. 3. The BS is assumed to form the beam for a k-th terminal of the terminals traveling in a service coverage area.

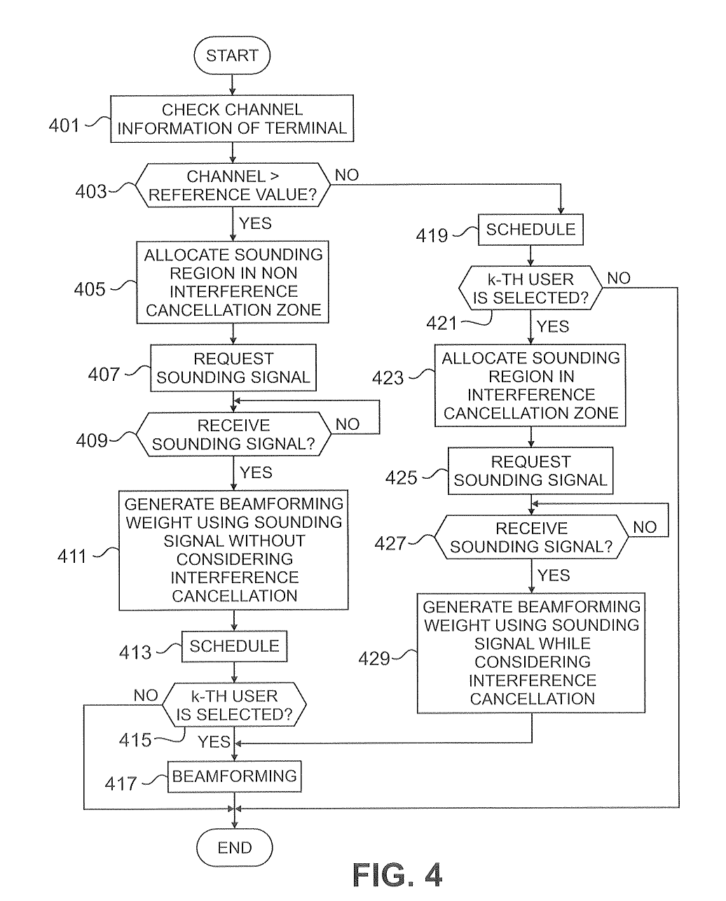

FIG. 4 illustrates a method for allocating the sounding channel at the transmitter of the wireless communication system according to an exemplary embodiment of the present invention.

In step 401, the BS checks channel information of the k-th terminal in the service area. For instance, the BS transmits a preamble to terminals traveling within the service area. The terminals feed channel information estimated from the preamble received from the BS, back to the BS. Hence, the BS confirms the channel information from the feedback signal received from the terminals. Herein, the channel information indicates SINR.

In step 403, the BS compares the channel information of the terminal with a preset reference value to determine a resource region to be allocated to the k-th terminal. Depending on a result of the comparison between the channel information of the terminal with the reference value, the BS determines whether to allocate the interference cancellation zone 310 or the non interference cancellation zone 320 of FIG. 3 to the terminal.

When the channel state information of the terminal is greater than the reference value, the BS determines that the terminal is not interfered by the neighbor cell in step 405. Thus, the BS allocates resources of the non interference cancellation zone to the terminal. Next, the BS allocates a sounding channel for the terminal by taking into account the channel information of the terminal. Herein, the BS allocates the sounding channel to the terminal using the resources of the non interference cancellation zone. The sounding channels of the terminals assigned the non interference cancellation zone differ based on the channel information of the terminals.

In step 407, the BS requests a sounding signal from the terminal. In doing so, the BS sends sounding signal request information and sounding channel information to the terminal.

In step 409, the BS checks whether a sounding signal is received over the allocated sounding channel.

Upon receiving the sounding channel, the BS generates a beamforming weight to form the beam to the terminal over the channel estimated using the sounding signal in step 411. When generating the beamforming weight, the BS does not consider the interference of the neighbor cell.

In step 413, the BS selects terminals to be serviced through scheduling. For example, the BS instantaneously performs scheduling in every beamforming using the channel information of the terminals. The BS selects a user having the greatest average ratio of transmittable data amount to previous data amount according to the channel information of the terminals.

In step 415, the BS checks whether the terminals to be serviced include the k-th terminal or not.

When the k-th terminal is selected as the terminal to be serviced, the BS forms the beam for the k-th terminal in step 417. In more detail, the BS forms the beam for the k-th terminal by multiplying the data to be sent to the k-th terminal by the beamforming weight generated in step 411.

By contrast, when the k-th terminal is not selected as the terminal to be serviced in step 415, the BS finishes this process. The BS forms the beam to the other terminals, excluding the k-th terminal, selected through scheduling.

When the channel information of the terminal is less than or equal to the reference value in step 403, the BS determines that the terminal is interfered by the neighbor cell in step 419. Hence, the BS determines to allocate resources of the interference cancellation zone to the terminal. Next, the BS selects terminals to be serviced amongst the terminals to be allocated to the interference cancellation zone through scheduling. Herein, the BS performs scheduling in the round robin manner. That is, the BS selects the terminals in turn. As a result, a neighbor BS can predict the scheduling information of the interference cancellation zone of the BS.

Next, the BS checks whether the k-th terminal is selected as the terminal to be serviced in step 421.

When the k-th terminal is not selected as the terminal to be serviced, the BS finishes this process.

When the k-th terminal is selected as the terminal to be serviced in step 421, the BS allocates a sounding channel for the terminal in step 423. That is, the BS allocates the fixed sounding channel in the interference cancellation zone to the terminal.

In step 425, the BS requests a sounding signal from the terminal. In doing so, the BS requests the sounding signal only from the terminals assigned the sounding channel. In allocating the fixed sounding channel to the terminal, the BS does not send a separate allocation information for the sounding channel.

In step 427, the BS checks whether a sounding signal is received from the terminals over the fixed sounding channel.

When the sounding signal is received, the BS generates a beamforming weight to form the beam to the terminal using a channel estimated from the sounding signal in step 429. Every BS allocates the fixed sounding channel of the interference cancellation zone using the same resource. Accordingly, the BS estimates the channel by receiving the sounding signals from not only the terminals serviced by the BS but also the interfered terminal in the neighbor cell over the fixed sounding channel. Next, the BS generates a beamforming weight for the k-th terminal by taking into consideration the interference of the neighbor cell using the channel information of the neighbor-cell terminal.

In step 417, the BS forms the beam for the k-th terminal using the beamforming weight.

Next, the BS finishes this process.

As above, the BSs fix and allocate the sounding channel in the interference cancellation zone with respect to the terminals interfered by the neighbor cell. Therefore, the BSs can estimate the channel by receiving the sounding signal from the terminal of the neighbor cell.

The BSs schedule the terminals allocated to the interference cancellation zone in a round robin manner so that the neighbor BSs can predict the scheduling information of the terminals assigned to the interference cancellation zone.

Thus, the BSs can mitigate the interference of the neighbor cell by forming the beam in consideration of the neighbor-cell interference using the channel information of the terminals allocated to the interference cancellation zone of the neighbor cell. Also, the BSs can avoid the unnecessary beamforming in consideration of the neighbor-cell interference by using the scheduling information of the terminals allocated to the interference cancellation zone of the neighbor cell.

When the BS schedules for the interference cancellation zone in a round robin manner, the k-th terminal is periodically selected as the terminal to be serviced. The BS requests the sounding signal by allocating the sounding channel only to the terminals to be serviced. The BS can be set to periodically transmit the sounding signal request to the k-th terminal over the fixed sounding channel every time the terminal is selected through scheduling. In this case, without a separate control signal, the BS can reduce the overhead on the control signal by means of the sounding signal request.

When a proportional fair (PF) scheduling is performed in the interference cancellation zone, the BS can increase the cell capacity through PF scheduling which reflects the instant channel state, compared to round-robin scheduling. Yet, since the terminals allocated to the interference cancellation zone are interfered by the neighbor cell, the channel state changes per frame because of the neighbor-cell interference. Consequently, under the real environment considering the feedback delay time, the BS attains a greater gain through the round-robin scheduling in the interference cancellation zone, compared to PF scheduling.

Now, operations of the terminal which receives data through beamforming of the BS are described.

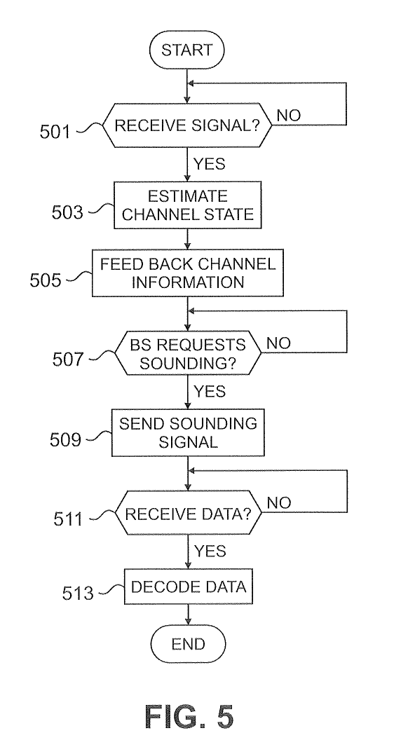

FIG. 5 illustrates a method for recovering data at a receiver of the wireless communication system according to an exemplary embodiment of the present invention.

In step 501, the terminal checks whether a signal is received from its serving BS.

When a signal is received, the terminal estimates a channel state to the serving BS using the received signal in step 503. For example, the terminal estimates the channel state to the serving BS using the preamble received from the serving BS.

In step 505, the terminal transmits the estimated channel information to the serving BS.

In step 507, the terminal checks whether the sounding request signal is received from the serving BS.

Upon receiving the sounding request signal, the terminal sends the sounding signal to the serving BS in step 509. For example, when the sounding request signal includes the sounding request information and the sounding channel information, the terminal sends the sounding signal to the serving BS through the indicated sounding channel. Otherwise, when the sounding request signal does not include the sounding channel information, the terminal sends the sounding signal to the serving BS over the sounding channel fixed in the interference cancellation zone.

In step 511, the terminal checks whether data is received from the serving BS.

Upon receiving the data, the terminal demodulates and decodes the received data in step 513.

Next, the terminal finishes this process.

As such, upon receiving the sounding request signal from the serving BS, the terminal transmits the sounding signal to the serving BS. Alternatively, when the terminal is allocated into the interference cancellation zone, the BS can set to periodically send the sounding signal to the terminal. Accordingly, the terminal sends the sounding signal to the serving BS on a preset periodic basis over the sounding channel fixed in the interference cancellation zone.

Hereafter, descriptions explains the structure of the BS for mitigating the neighbor-cell interference using beamforming in the wireless communication system.

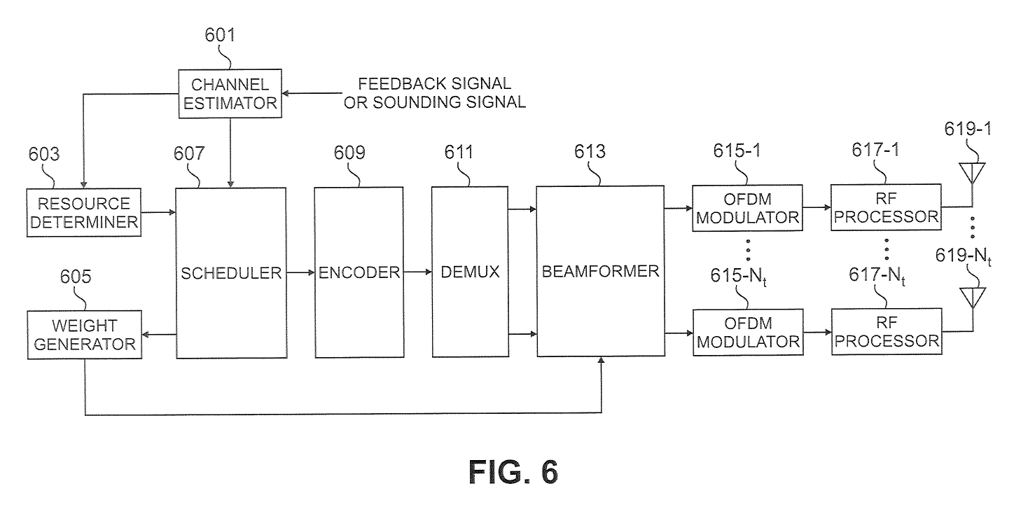

FIG. 6 is a block diagram of a transmitter for canceling neighbor-cell interference in the wireless communication system according to an exemplary embodiment of the present invention.

The BS of FIG. 6 includes a channel estimator 601, a resource determiner 603, a weight generator 605, a scheduler 607, an encoder 609, a demultiplexer (DEMUX) 611, a beamformer 613, orthogonal frequency division multiplexing (OFDM) modulators 615-1 through 615-Nt, radio frequency (RF) processors 617-1 through 617-Nt, and antennas 619-1 through 619-Nt. The OFDM modulators 615-1 through 615-Nt and the RF processors 617-1 through 617-Nt are provided for the respective antennas 619-1 through 619-Nt.

The channel estimator 601 estimates the channel information of the terminals in the service area. For example, the channel estimator 601 estimates the channel information of the terminals using the sounding signals received from the terminals. The channel estimator 601 can also estimate the channel information of the terminals in the interference cancellation zone of the neighbor cell by receiving the sounding signals from the terminals in the interference cancellation zone of the neighbor cell.

The resource determiner 603 determines the resource regions to be allocated to the terminals by taking into account the channel information of the terminals provided from the channel estimator 601. For example, when the SINR of the terminal is greater than the reference value, the resource determiner 603 determines that the terminal is not interfered by the neighbor cell. Hence, the resource determiner 603 assigns the terminal into the non interference cancellation zone 320 of FIG. 3.

When the SINR is less than or equal to the reference value, the resource determiner 603 determines that the terminal is interfered by the neighbor cell. Hence, the resource determiner 603 assigns the terminal into the interference cancellation zone 310 of FIG. 3.

The scheduler 607 selects the terminals to be serviced by scheduling for the interference cancellation zone 310 and the non interference cancellation zone 320. The scheduler 607 performs scheduling by taking into account the terminals allocated to the regions determined at the resource determiner 603. For example, the scheduler 607 schedules for the interference cancellation zone 310 in a round robin fashion. For the non interference cancellation zone 320, the scheduler 607 schedules using the channel information of the terminals provided by the channel estimator 601.

The scheduler 607 requests the sounding signal only from the terminals selected through scheduling among the terminals assigned the interference cancellation zone 310. By contrast, the scheduler 607 requests the sounding signal from every terminal allocated in the non interference cancellation zone 320. Accordingly, the scheduler 607 performs scheduling by taking into account the channel estimated from the sounding signals received from the terminals of the non interference cancellation zone 320.

The scheduler 607 predicts the scheduling information of the terminals in the interference cancellation zone 310 of the neighbor cell and provides the predicted scheduling information to the weight generator 605. For example, the neighbor cells perform scheduling for the interference cancellation zone 310 in round robin fashion as well. Hence, when the weight generator 605 generates the beamforming weight, the scheduler 607 can predict the scheduling information of the terminals in the interference cancellation zone 310 of the neighbor cell. Alternatively, the neighbor cells also send the sounding signal only to the terminals to be serviced amongst the terminals allocated to the interference cancellation zone 310. Accordingly, the scheduler 607 can predict the scheduling information of the terminals in the interference cancellation zone 310 of the neighbor cell according to the information of the terminal which sends the sounding signal over the sounding channel fixed in the interference cancellation zone 310.

The weight generator 605 generates the beamforming weight to form the beam for the terminal to which the data is transmitted. For example, to generate the beamforming weight for the interference cancellation zone 310, the weight generator 605 confirms the scheduling information of the terminals in the interference cancellation zone 310 of the neighbor cell. When the terminal of the neighbor cell interfered by the BS is serviced by the neighbor BS during beamforming, the weight generator 605 generates the beamforming weight taking into consideration the neighbor-cell interference using the channel information of the terminal to be serviced and the channel information of the neighbor-cell terminal. By contrast, when the terminal of the neighbor cell interfered by the BS is not serviced by the neighbor BS during beamforming, the weight generator 605 generates the beamforming weight using the channel information of the terminal to be serviced.

Alternatively, in generating the beamforming weight for the non interference cancellation zone 320, the weight generator 605 uses the channel information of the terminal to be serviced.

The encoder 609 codes and modulates the transmit data according to a corresponding modulation level. Herein, the modulation level indicates a modulation and coding scheme (MCS) level.

The DEMUX 611 demultiplexes the modulation symbols provided from the encoder 609 to transmit them over the antennas 619-1 through 619-Nt respectively.

The beamformer 613 multiplies the symbols output from the DEMUX 611 by the beamforming weights output from the weight generator 605. Herein, the first antenna signal is output to the first OFDM modulator 615-1 and the Nt-th antenna signal is output to the Nt-th OFDM modulator 615-Nt.

The OFDM modulators 615-1 through 615-Nt OFDM-modulate the signals which are provided from the beamformer 613 and to be sent to the antennas. Herein, the OFDM modulators 615-1 through 615-Nt OFDM-modulate the transmit signals using Inverse Fast Fourier Transform (IFFT). The OFDM modulators 615-1 through 615-Nt append a cyclic prefix (CP) to the data which passes through the IFFT operation, to generate OFDM symbols in the end.

The RF processors 617-1 through 617-Nt convert the data output from the OFDM modulators 615-1 through 615-Nt to an analog signal. Next, the RF processors 617-1 through 617-Nt convert the analog signal to a transmittable RF signal and transmit the RF signal via the corresponding antennas.

As set forth above, the wireless communication system allocates the fixed sounding channel of the interfered terminals and schedules in a round robin fashion. The transmitter forms the beam taking into consideration the neighbor-cell interference by acquiring the channel information of the neighbor-cell terminals interfered by the transmitter and the scheduled terminal information during beamforming. Therefore, the neighbor-cell interference can be mitigated.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A method for canceling an interference at a transmitter in a wireless communication system, the method comprising:
confirming a channel information of one or more terminals;
classifying each of the one or more terminals as terminals interfered by a neighbor cell or as terminals not interfered by the neighbor cell based on the channel information of the one or more terminals; and
allocating the terminals interfered by the neighbor cell and the terminals not interfered by the neighbor cell into different resource regions.

2. The method of claim 1, wherein confirming a channel information comprises:
confirming a signal to interference and noise ratio (SINR) of the one or more terminals using a sounding signal received from the one or more terminals.

3. The method of claim 1, wherein allocating into resource regions comprises:
dividing radio resources into two regions in a frequency axis;
allocating the terminals interfered by the neighbor cell to a first region; and
allocating the terminals not interfered by the neighbor cell to a second region.

4. The method of claim 1, wherein, in the resource region allocated to the terminals interfered by the neighbor cell, a sounding channel has a fixed position and a fixed size.

5. The method of claim 4, wherein the sounding channel in the resource region allocated to the terminals interfered by the neighbor cell has an identical position and size in every cell.

6. The method of claim 1, further comprising:
scheduling for the resource regions;
requesting a sounding signal from one or more terminals selected through a scheduling with respect to the resource region allocated to the terminals interfered by the neighbor cell;
upon receiving a sounding signal, estimating a channel for the terminals selected through the scheduling and one or more neighbor-cell terminals using the sounding signal; and
forming a beam to the selected terminals by taking into account an interference of a neighbor cell using the channel of the selected terminals and the neighbor-cell terminals.

7. The method of claim 6, wherein scheduling comprises:
scheduling in a round robin fashion for the resource region allocated to the terminals interfered by the neighbor cell.

8. The method of claim 6, wherein the neighbor-cell terminals represent terminals interfered by a base station amongst terminals in a neighbor cell.

9. The method of claim 6, wherein forming a beam comprises:
checking a scheduling information of a neighbor-cell terminal;
when the neighbor cell services the neighbor-cell terminal during beamforming to the selected terminals, generating a weight using channel information of the selected terminals and a channel information of the neighbor-cell terminals; and
multiplying a data to be transmitted to the selected terminals by the weight and transmitting the data.

10. The method of claim 9, further comprising:
when the neighbor cell does not service the neighbor-cell terminal during beamforming to the selected terminals, generating a weight using the channel information of the selected terminals; and
multiplying a data to be transmitted to the selected terminals by the weight and transmitting the data.

11. An apparatus for a transmitter in a wireless communication terminal, comprising:
a channel estimator for estimating a channel information for one or more terminals;
a resource determiner for classifying the terminals into terminals interfered by a neighbor cell and terminals not interfered by the neighbor cell based on the channel information of the terminals, and allocating the classified terminals into different resource regions; and
a scheduler for selecting one or more terminals to be serviced by scheduling on a resource region basis.

12. The apparatus of claim 11, wherein the channel estimator estimates a signal to interference and noise ratio (SINR) of the terminals using sounding signals received from the terminals.

13. The apparatus of claim 11, wherein the channel estimator estimates a channel information of one or more terminals to be serviced and one or more neighbor-cell terminals using the sounding signals received over a sounding channel of the resource region allocated to the terminals interfered by the neighbor cell, the sounding channel allocated at a same position in a same size in every cell.

14. The apparatus of claim 13, wherein the neighbor-cell terminals represent terminals interfered by a base station amongst terminals in a neighbor cell.

15. The apparatus of claim 11, wherein the resource determiner allocates the terminals interfered by the neighbor cell to a first region and allocates the terminals not interfered by the neighbor cell to a second region by dividing radio resources into two regions in a frequency axis based on the channel information of the terminals.

16. The apparatus of claim 11, wherein the scheduler schedules in a round robin fashion for the resource region allocated to the terminals interfered by the neighbor cell.

17. The apparatus of claim 11, wherein the scheduler requests a sounding signal from one or more terminals selected through the scheduling amongst the terminals interfered by the neighbor cell.

18. The apparatus of claim 11, further comprising:
a weight generator for generating a weight to form a beam using the channel information of the terminals selected through the scheduling; and
a beamformer for multiplying a data to be transmitted to the selected terminals by the weight and transmitting the data.

19. The apparatus of claim 18, wherein, when the neighbor cell services the neighbor-cell terminal during beamforming to the terminals selected through the scheduling, the weight generator generates a weight for the terminals interfered by the neighbor cell using the channel information of the selected terminals and the channel information of the neighbor-cell terminals.

20. The apparatus of claim 18, wherein, when the neighbor cell does not service the neighbor-cell terminal during beamforming to the terminals selected through the scheduling, the weight generator generates a weight for the terminals interfered by the neighbor cell using the channel information of the selected terminals.
